(19) United States
(12) Patent Application Publication
(10) Pub. No.: US 2002/0039331 A1
(43) Pub. Date: Apr. 4, 2002

(54) Header region detecting method and apparatus and recording/reproducing method and apparatus using thereof for optical recording medium

(76) Inventor: Sang On Park, Kyonggi-do (KR)

Correspondence Address: BIRCH STEWART KOLASCH & BIRCH, PO BOX 747, FALLS CHURCH, VA, 22040-0747, US

(21) Appl. No.: 09/949,800

(22) Filed: Sep. 12, 2001

(30) Foreign Application Priority Data
Oct. 2, 2000 (KR) 2000-57905

(51) Int. Cl. G11B 7/095

(52) U.S. Cl. 369/44.26; 369/44.34

(57) ABSTRACT

A header region detecting method and apparatus and recording/reproducing method and apparatus using thereof for an optical recording medium is disclosed. According to the method and apparatus, a tracking error signal is detected by detecting an RF signal from an optical reflected signal inputted from the optical recording medium and obtaining a phase difference of optical reflected signals in a radial direction based on the RF signal. Then, first and second header detection signals are generated by slicing the detected tracking error signal with predetermined upper and lower slice levels, and a header region is detected by logically combining the first and second header detection signals, so that the header region can be accurately and stably detected even in a free running or traverse operation. Also, by holding the servo error signals such as focusing error and tracking error signals accurately and stably, the servo becomes stabilized, and deterioration of the data quality can be prevented during the recording/reproducing operation.

### BACKGROUND OF THE INVENTION

1. Field of the Invention

The present invention relates to a recording/reproducing system for a rewritable optical recording medium, and more particularly, to a header region detecting method and apparatus and recording/reproducing method and apparatus using thereof for an optical recording medium having the header region.

2. Background of the Related Art

As the storage capacity of the existing CD-ROM title is gradually reaching the uppermost limit, a digital versatile disc (DVD) is spotlighted as a new storage medium. This DVD is not so different from a compact disc (CD) in implementation principle. That is, the DVD recognizes data on the same principle as the CD that recognizes data of 0 and 1 by the difference of reflected light quantity using a laser. However, the width of data storage of the DVD is minute in comparison to the CD.

In the same manner as the CD, the DVD is briefly classified into three types according to its function and purpose: a read only memory (ROM) type (for example, DVD-ROM), write one read many (WORM) type (for example, DVD-R) on which data can be written only once, and rewritable type (for example, DVD-RW, DVD-RAM, and DVD+RW) on which data can be repeatedly written.

FIG. 1 is a block diagram illustrating the construction of a general optical disc recording/reproducing apparatus for recording and reproducing data in the above-described DVD series optical discs. Referring to FIG. 1, an optical pickup 102, under the control of a servo control section 104, puts an optical beam condensed by an object lens on a signal track of an optical disc. The optical beam reflected from a signal recording surface of the optical disc is condensed through the object lens, and then incident to an optical detector for detection of a focus error signal and a tracking error signal.

The optical detector is composed of a plurality of optical detection elements, and electric signals in proportion to light quantities obtained by the respective optical detection elements are outputted to an RF and servo error generating section 103.

The RF and servo error generating section 103 detects an RF signal for data reproduction, focus error (FE) signal for servo control, tracking error (TE) signal, etc., from the electric signals outputted from the respective optical detection elements of the optical detector.

The detected RF signal is outputted to a data decoder for reproduction, and the servo error signals such as the TE and TE signals are outputted to the servo control section 104.

The servo control section 104 processes the focus error (FE) signal to output a driving signal for focus control to a focus servo driving section 105, and processes the tracking error (TE) signal to output a driving signal for tracking control to a tracking servo driving section 106.

Then, the focus servo driving section 105 moves the optical pickup 102 up and down by driving a focus actuator in the optical pickup 102, so that the optical pickup 102 follows the up/down movement of the rotating optical disc 101.

The tracking servo driving section 106 moves the object lens of the optical pickup 102 in a radial direction by driving a tracking actuator in the optical pickup 102, and thus corrects the position of the beam to follow a specified track.

The RF and servo error generating section 103 and servo control section 104 generally use various kinds of tracking control methods such as a three-beam method, push-pull (PP) method, differential phase detection (DPD) method, etc., for the tracking control in the DVD series optical discs.

According to the push-pull (PP) method, the optical detection elements of the optical detector for detecting the optical beam reflected from the optical disc are divided into two parts in a track direction, and the tracking error signal is detected from a light quantity balance of the two-divided optical detection elements. Specifically, this method uses the fact that the intensity distribution of light, that is diffracted and reflected by a pit and then incident again to the object lens, varies according to the relative positional change of the pit and spot.

At this time, if the shadow of the pit is equally detected by the both optical detection elements, the tracking error (TE) signal becomes “0”, and this state is called a tracking-on (or on-track) state. On the contrary, if the optical beam deviates left or right from the track center, the tracking error (TE) signal has a positive (+) or negative (−) value, and this state is called a tracking-off (or off-track) state.

The PP method has several conditions. According to one among them, if the wavelength of the light is λ and the depth of the pit is λ/4, i.e., if the diffraction by the pit is most effective and the depth of modulation becomes maximum, the tracking error signal cannot be obtained through the PP method. In other words, since the pattern becomes symmetric when the depth of the pit is λ/4, the tracking error signal cannot be obtained through the 2-divided optical detector.

Meanwhile, the DPD method is an improvement of the PP method. In the same manner as the PP method, the DPD method uses the intensity distribution of light according to the relative positional change of the beam and pit, but it uses a 4-divided optical detector instead of the 2-divided optical detector.

Specifically, according to the DPD method, the intensity distribution of light is received through the 4-divided optical detector, and the tracking error signal is generated through the detection of phase difference in the radial direction.

Accordingly, the tracking error signal is outputted even if the depth of the pit is λ/4, and is not much affected by the movement of the beam on the optical detector as well.

For example, as shown in FIG. 2, in case that the optical detector is composed of 4 optical detection elements PDA, PDB, PDC, and PDD divided in the signal track direction and radial direction of the optical disc, the optical detector outputs electric signals a, b, c, and d in proportion to the light quantities obtained by the respective optical detection elements PDA, PDB, PDC, and PDD.

At this time, the DPD method obtains the tracking error (TE) signal through the detection of the phase difference between diagonal difference signals, i.e., between the electric signal of “a+c” and the electric signal of “b+d” at a slice point of the RF signal of “a+b+c+d” obtained from the electric signals a, b, c, and d outputted from the optical detector. That is, by detecting the phase difference, the positive TE signal can be obtained. As described above, the TE signal according to the DPD method is generated using the phase difference in the radial direction detected while the object lens passes the pit on the track.

As shown in FIG. 3B, if the track is in the center of the beam, the DPD signal becomes zero, and this value is maintained even if the beam moves in a direction as indicated as an arrow by the rotation of the disc. This means that the phase difference signal in the diagonal direction is not generated.

Meanwhile, as shown in FIGS. 3A and 3C, if the beam deviates from the track and moves in a direction as indicated as an arrow, the DPD signal becomes an output of sine wave. The phase of the sine wave deviates by ±90° with respect to that of the RF signal. Thus, by detecting the phase of the DPD signal at the slice point of the RF signal based on the RF signal, the positive and negative tracking error signals can be obtained.

Hereinafter, the tracking error signal obtained through the PP method is referred to as a PP signal, and the tracking error signal obtained through the DPD method is referred to as a DPD signal.

Also, in case that the optical detector is divided into two in the track direction, the tracking error signal is detected from the light quantity balance of both photodiodes I1 and I2 through the PP method. That is, the electric signals a and d correspond to the photodiode I1, and the electric signals b and c correspond to the photodiode I2.

At this time, the DVD-ROM generates the tracking error signal using the DPD method. Specifically, since the depth of the pit is λ/4 in case of the DVD-ROM, the tracking error signal cannot be detected through the PP method. Thus, the DVD-ROM obtains the tracking error signal using the DPD method. Also, the DVD-R or DVD-RW detects the tracking error signal using the DPD method in case of reproducing a region where the signal is recorded, while it detects the tracking error signal using the PP method in case of recording the signal. Also, the DVD-RAM detects the tracking error signal using the DPD method only with respect to a pre-pit region, while it detects the tracking error signal using the PP method with respect to other regions.

Meanwhile, if the optical disc 101 is the rewritable disc, for example, the DVD-RAM, the signal track has a land/groove structure, and position information is recorded according to respective disc format so as to recognize the position even in a disc where no signal is recorded. Also, in order to heighten the recording density of the rewritable disc, an information signal is recorded on the respective tracks of the land and groove.

At this time, since the original disc has no information recorded thereon, it is impossible to perform a disc control and recording.

For this, a disc track is formed on the land and groove, and information is recorded along the corresponding track. Also, control information for sector address, random access, rotation control, etc., is separately recorded on the disc. This enables the tracking control to be performed even in a blank disc where no information signal is recorded. The control information can be recorded by pre-formatting a header region in a start position of each sector.

At this time, in case of the DVD-RAM, the header region pre-formatted at the start position of each sector is composed of four header fields, i.e., header 1 field˜header 4 field. Here, the header 1,2 fields are alternately arranged with the header 3,4 fields. FIG. 4 shows an example of the header field structure of the first sector in a track.

However, the header region structure as described above actually exerts a bad effect on generation of the servo error signal such as the tracking error signal and focus error signal. That is, the servo error signal read out from the header region is distorted according to the header structure, and it is difficult to control such distortion. Especially, in case that the header region is arranged in zigzag with respect to the track center as shown in FIG. 4, it causes a great disturbance to the track control signal, and thus the header region is masked for various advantages such as the stability of track control, noise removal, etc. Also, since the header region is an abnormal operation part in view of the error detection, a track jump and so on should be performed to avoid this part.

Accordingly, in case of the DVD-RAM, in order to generate the servo error signal and control the servo error signal stably, the servo control is performed so as to reduce the effect of the header by holding the respective servo error signals in the header region.

For this, it is required to judge the header region. Conventionally, the header region is detected using a read channel signal.

FIG. 5 illustrates the construction of a conventional header region detecting apparatus, which uses a read channel 2 signal. Referring to FIG. 5, a low pass filter (LPF) 201 produces the tracking error (TE) signal by receiving and low-pass-filtering the read channel 2 signal (for example, ad-bc) generated from the RF and servo error generating section 103 of FIG. 1, and outputs the TE signal to first and second comparators 202 and 203.

At this time, since the header regions, i.e., the header 1,2 fields and the header 3,4 fields, are alternately arranged on the basis of the track center, the read channel 2 signals detected in the header 1,2 fields and the header 3,4 fields are opposite to each other in phase (i.e., slope) as shown in FIG. 6A.

The read channel 2 signal of the header region passes through the LPF 201, and the tracking error (TE) signal from which the noise is removed as shown FIG. 6B is outputted from the LPF 201.

The first comparator 202 outputs an IP1 signal as shown as FIG. 6C if the tracking error (TE) signal inputted to its plus terminal is higher than the slice level inputted to its minus terminal. The second comparator 203 outputs an IP2 signal as shown in FIG. 6D if the tracking error (TE) signal inputted to its minus terminal is lower than the slice level inputted to its plus terminal. Here, it is assumed that a tracking zero cross (TZC) position is determined as the slice level.

At this time, the phases of the IP1 signal and the IP2 signal as shown in FIGS. 6C and 6D are changed each other according to the currently followed track, i.e., whether the currently followed track is the land or the groove.

Then, a signal generating section 204 detects the header region as shown in FIG. 6E by OR-gating the IP1 signal and the IP2 signal.

Accordingly, the signal as shown in FIG. 6E is used as a header mask signal that represents the header region, and in the header region, the respective servo error signals are held to reduce the effect of the header.

Meanwhile, the read channel 2 signal as shown in FIG. 6A is detected in a state that the servo is stable, i.e., in a state that the tracking servo and the focus servo are all in an on state. Thus, the signal can be easily applied in case that the servo is stably performed and the IP1 and IP2 signals are accurately detected in the header region. However, it is always possible that a signal having a similar waveform to the read channel 2 signal is detected in any place of the disc, and this possibility is heightened in case that the system is unstable.

If the tracking servo is in an off state, i.e., in a traverse or free running state, the servo becomes unstable, and the IP1 and IP2 signals are unstably detected. Also, it is unreliable if the detected IP1 and IP2 signals are detected in the header region.

This causes the header region not to be properly detected, and causes the judgment of land/groove track to be inaccurate.

Here, in the traverse state, the servo error signal is detected while the disc is rotated and the optical pickup is moved in a state that the tracking servo is off and the focus servo is on. The traverse is mainly used for a seek operation such as a track jump. In the free running state, the servo error signal is detected while the disc is rotated and the optical pickup is fixed in a state that the tracking servo is off and the focus servo is on. The free running is mainly used for measuring an amount of eccentricity of the disc.

Meanwhile, if the header region is not detected properly, the servo error signal cannot be held in the header region, and the servo error signal is affected by the header.

That is, if the read channel 2 signal is used for holding the header region, the distortion is produced in the servo error signal such as the focus error signal and the tracking error signal especially under the bad effect caused by the traverse for the seek operation or the free running for measurement of the amount of eccentricity.

FIG. 7A illustrates the read channel 2 signal detected in a sector where data recording is possible and a header region for representing the position of the sector, and FIG. 7B illustrates a TZC signal generated by slicing the read channel 2 signal at a TZC position, which is affected by the header.

As shown in FIG. 7A, the read channel 2 signal detected in the region where the data recording is possible such as the sector is represented as sine waves, and the read channel 2 signal detected in the header region is represented as impulses. This is because the header region is very short in comparison to the sector, and thus the pulse width of the read channel 2 signal detected in the header region is greatly narrow in comparison to that of the sector.

As shown in FIG. 7B, the region affected by the header is represented in circles. In the circles, the header region cannot be detected, and thus the servo error signal cannot be held to produce more pulses.

At this time, it can be recognized how many tracks have passed by counting the pulse number of the TZC signal. Thus, the position where the optical pickup is currently moved can be recognized during the traverse, and the amount of eccentricity of the disc can be measured during the free running.

However, since the conventional apparatus cannot detect the header region properly, and thus the more pulses are generated from the TZC signal due to the effect of the header as shown in FIG. 7B, the following problems are produced.

First, since the servo error signal such as the tracking error signal and the focus error signal cannot be held in the header region, the servo becomes unstable, and this causes the data quality to deteriorate during the data recording/reproduction.

Second, since more pulses are generated during the measurement of the amount of eccentricity in comparison to those generated in the normal state, it is misjudged that the amount of eccentricity is greater than the actual amount of eccentricity, and this exerts a bad effect on the servo.

Third, since the optical pickup cannot go to a desired position during the seek operation, the seek operation becomes slow, and the servo becomes unstable. For example, if more pulses are generated due to the effect of the header, it is misjudged that the optical pickup has passed 10 tracks although the optical pickup has actually passed 8 tracks, and the movement of the optical pickup is stopped after passing 8 tracks.

Fourth, since the header region corresponds to the time point when the disturbance is inputted, the tracking servo should be turned on with the header region avoided. However, if the header region is not detected properly, the tracking servo may be turned on in the header region, and this causes the servo to be unstable.

Fifth, since the land and the groove have different recording power, focus offset, tracking offset, etc., and the phase of the tracking error signals are opposite each other, the land and the groove should be discriminated and the land/groove switching should be performed to match the recording powers, offsets, etc., of the land and the groove. At this time, the land and the groove can be discriminated and switched by counting the number of headers. However, the header region is not detected properly, the land/groove switching cannot be performed accurately.

### SUMMARY OF THE INVENTION

Accordingly, the present invention is directed to a header region detecting method and apparatus and recording/reproducing method and apparatus using thereof for an optical recording medium that substantially obviates one or more problems due to limitations and disadvantages of the related art.

An object of the present invention is to provide a header region detecting method and apparatus and recording/reproducing method and apparatus using thereof for an optical recording medium that controls the recording/reproduction of the optical disc by generating a signal representing the header region using a tracking error (TE) signal detected through a differential phase detection (DPD) method.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a header region detecting method for an optical recording medium comprises the steps of (a) generating a tracking error signal by detecting an RF signal from an optical reflected signal inputted from the optical recording medium and obtaining a phase difference of optical reflected signals in a radial direction based on the RF signal; (b) generating first and second header detection signals by slicing the generated tracking error signal with a predetermined slice level; and (c) generating a signal representing a header region by logically combining the first and second header detection signals.

Preferably, at the step (b), if the tracking error signal is higher than the slice level, the first header detection signal is generated, while if the tracking error signal is lower than the slice level, the second header detection signal is generated. Here, the first and second slice levels may be equal or different from each other.

Preferably, the method further comprises the step of performing a servo control by sampling and holding the servo error signal if the signal representing the header region is inputted at the step (c).

Preferably, the method further comprises the step of discriminating whether a present track is a land signal track or a groove signal track by comparing phases of the first and second header detection signals generated at the step (b), and generating a land/groove discrimination signal according to a result of discrimination.

In another aspect of the present invention, a recording/reproducing method for an optical recording medium comprises the steps of (a) generating a tracking error signal by detecting an RF signal from an optical reflected signal inputted from the optical recording medium and obtaining a phase difference of optical reflected signals in a radial direction based on the RF signal; (b) generating a tracking error signal by receiving two optical reflected signals divided in a track direction from the optical recording medium and obtaining a difference between the two optical reflected signals; (c) generating first and second header detection signals by slicing the tracking error signal generated at the step (a) with a predetermined slice level, and generating a signal representing a header region by logically combining the first and second header detection signals; (d) discriminating whether a present track is a land signal track or a groove signal track by comparing phases of the first and second header detection signals, and generating a land/groove discrimination signal according to a result of discrimination; and (e) recording/reproducing data by performing a tracking control by sampling and holding the tracking error signal generated at the step (b) if the signal representing the header region is inputted at the step (c), and by performing a tracking control by the tracking error signal generated at the step (b) in other cases.

Preferably, at the step (e), if the land/groove discrimination signal represents the groove signal track, a tracking servo is performed by offset-adjusting the tracking error signal to match the groove signal track, while if the land/groove discrimination signal represents the land signal track, a tracking servo is performed by offset-adjusting and inverting the tracking error signal to match the land signal track.

In still another aspect of the present invention, a header region detecting apparatus for an optical recording medium comprises a differential phase detection (DPD) signal generating section for generating a tracking error signal by detecting an RF signal from an optical reflected signal inputted from the optical recording medium and obtaining a phase difference of optical reflected signals in a radial direction based on the RF signal; a slicing section for generating first and second header detection signals by slicing the tracking error signal generated by the DPD signal generating section with a predetermined slice level; and a header region discriminating section for generating a signal representing a header region by logically combining the first and second header detection signals.

Preferably, the apparatus further comprises a servo control section for performing a servo control by sampling and holding the servo error signal if the signal representing the header region is outputted from the header region discriminating section.

Preferably, the apparatus further comprises a land/groove signal generating section for discriminating whether a present track is a land signal track or a groove signal track by comparing phases of the first and second header detection signals generated from the slicing section, and generating a land/groove discrimination signal according to a result of discrimination.

Preferably, the servo control section performs a tracking servo by offset-adjusting the tracking error signal to match the groove signal track if the land/groove discrimination signal represents the groove signal track, while performs a tracking servo by offset-adjusting and inverting the tracking error signal to match the land signal track if the land/groove discrimination signal represents the land signal track.

In still another aspect of the present invention, a recording/reproducing apparatus for an optical recording medium comprises a differential phase detection (DPD) signal generating section for generating a tracking error signal by detecting an RF signal from an optical reflected signal inputted from the optical recording medium and obtaining a phase difference of optical reflected signals in a radial direction based on the RF signal; a push-pull signal generating section for generating a tracking error signal by receiving two optical reflected signals divided in a track direction from the optical recording medium and obtaining a difference between the two optical reflected signals; a header region detecting section for generating first and second header detection signals by slicing the tracking error signal generated from the DPD signal generating section with a predetermined slice level, and generating a signal representing a header region by logically combining the first and second header detection signals; a land/groove signal generating section for discriminating whether a present track is a land signal track or a groove signal track by comparing phases of the first and second header detection signals from the header region detecting section, and generating a land/groove discrimination signal according to a result of discrimination; and a servo control section for recording/reproducing data by performing a tracking control by sampling and holding the tracking error signal generated from the push-pull signal generating section if the signal representing the header region is inputted from the header region detecting section, and by performing a tracking control by the tracking error signal that is not sampled and held in other cases.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a block diagram illustrating the construction of a general optical disc recording/reproducing apparatus;

FIG. 2 is a view illustrating an example of a general optical detector that generates a tracking error signal using a DPD method;

FIGS. 3A to 3C are views illustrating the principle of a general DPD method;

FIG. 4 is a view illustrating an example of a header arrangement pre-formatted at a start position of each sector in a general rewritable disc;

FIG. 5 is a block diagram illustrating the construction of a conventional header region detecting apparatus;

FIGS. 6A to 6E are waveform diagrams illustrating the waveforms obtained through the header region detecting process using the read channel 2 signal in FIG. 5;

FIG. 7A is a waveform diagram illustrating the read channel 2 signal detected in a sector where data recording is possible and a header region;

FIG. 7B illustrates a TZC signal generated by slicing the read channel 2 signal of FIG. 7A at a TZC position, which is affected by the header;

FIGS. 8A to 8C are waveform diagrams illustrating a read channel 2 signal, RF signal, and DPD signal detected in the whole recording region during a traverse operation;

FIGS. 9A to 9C and 10A to 10C are waveform diagrams illustrating a read channel 2 signal, RF signal, and DPD signal, respectively, detected in a header region that is a non-recording region during a traverse operation;

FIG. 11 is a block diagram illustrating an optical disc recording/reproducing apparatus for detecting a header region according to the present invention; and

FIGS. 12A to 12F are waveform diagrams illustrating the waveforms at various parts of FIG. 11.

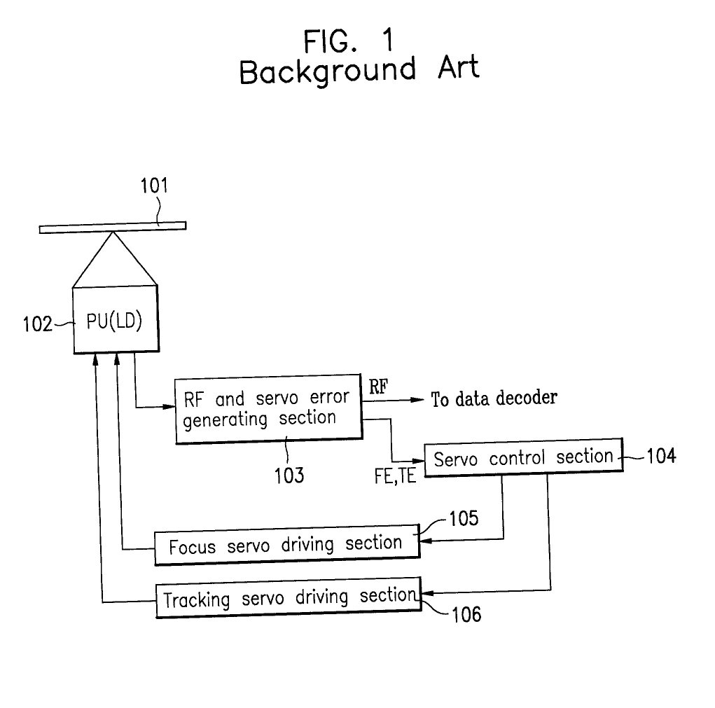

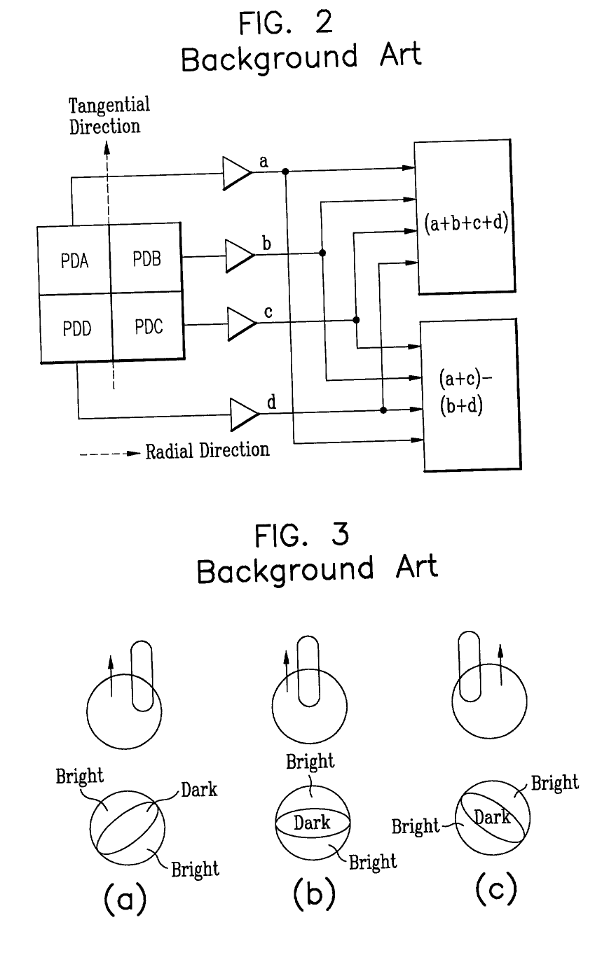

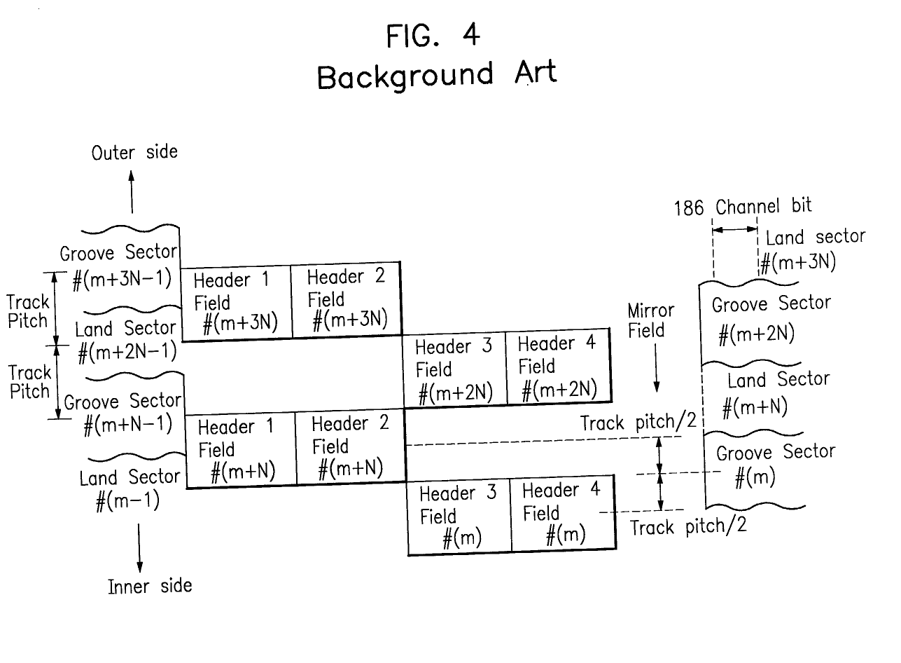

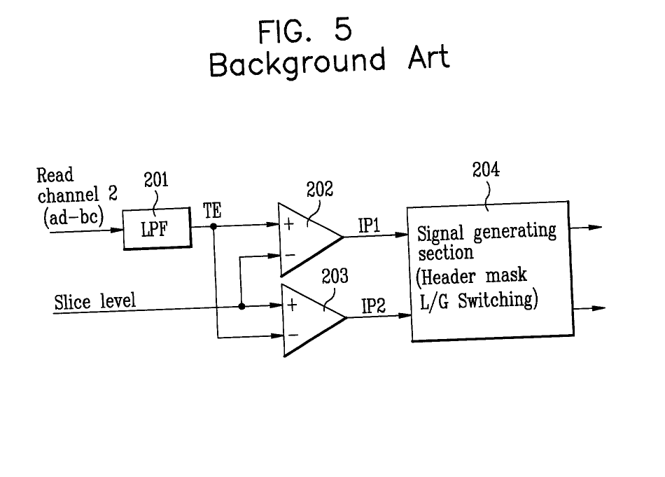

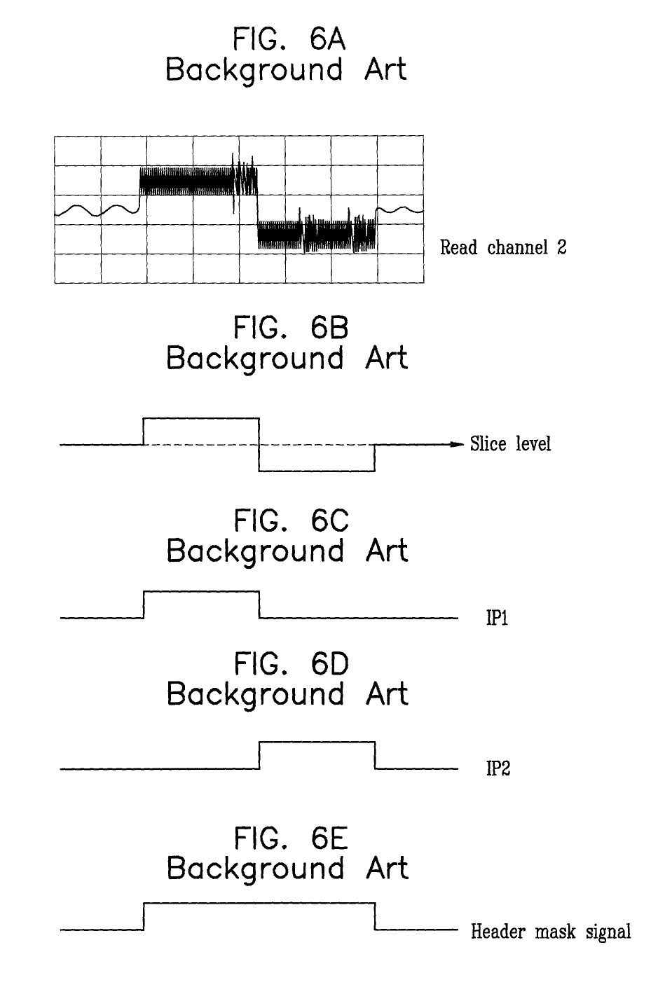

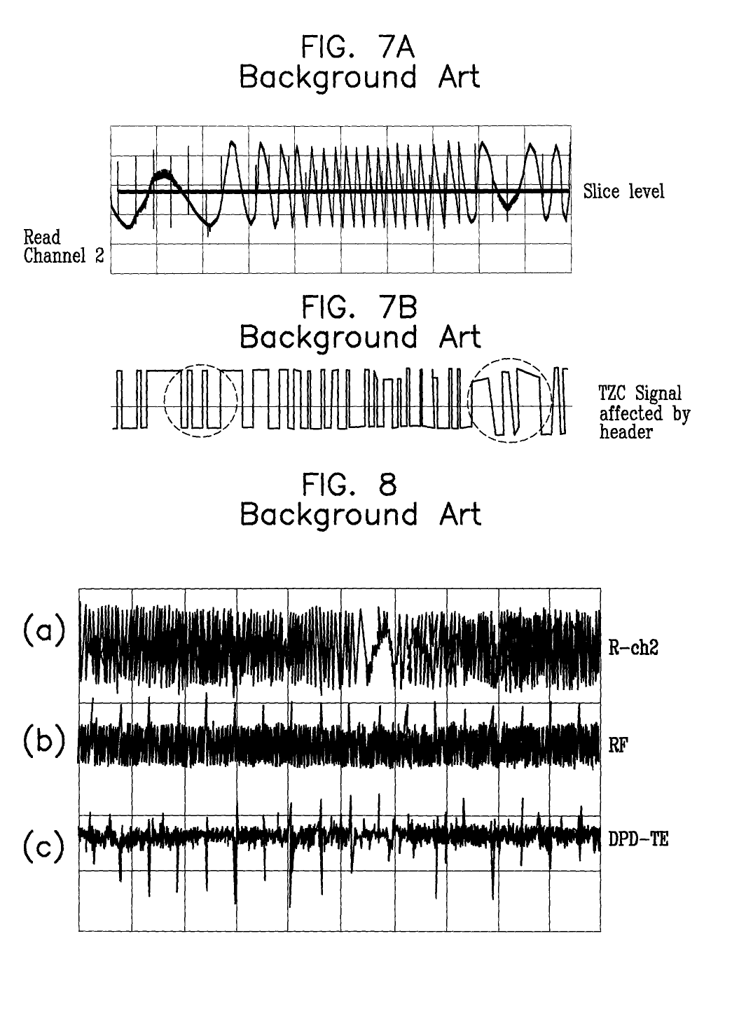

### DETAILED DESCRIPTION OF THE PREFERRED EMBODIMENTS

Reference will now be made in detail to the preferred embodiments of the present invention, examples of which are illustrated in the accompanying drawings.

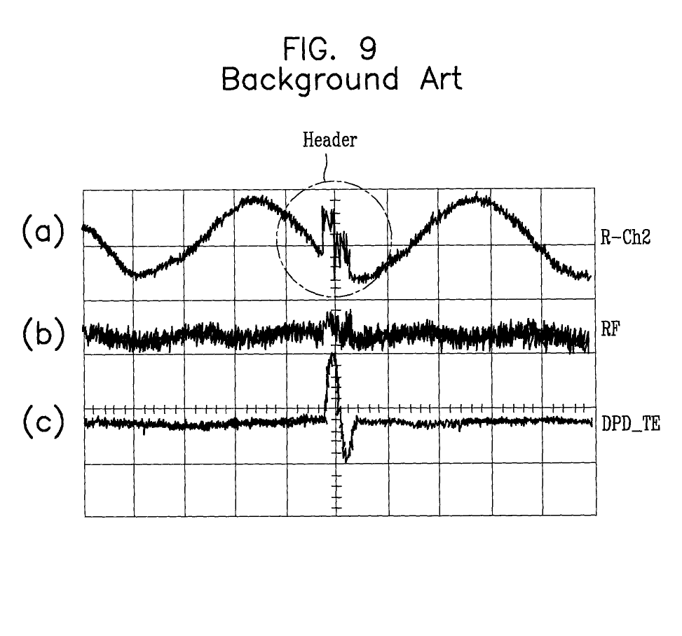

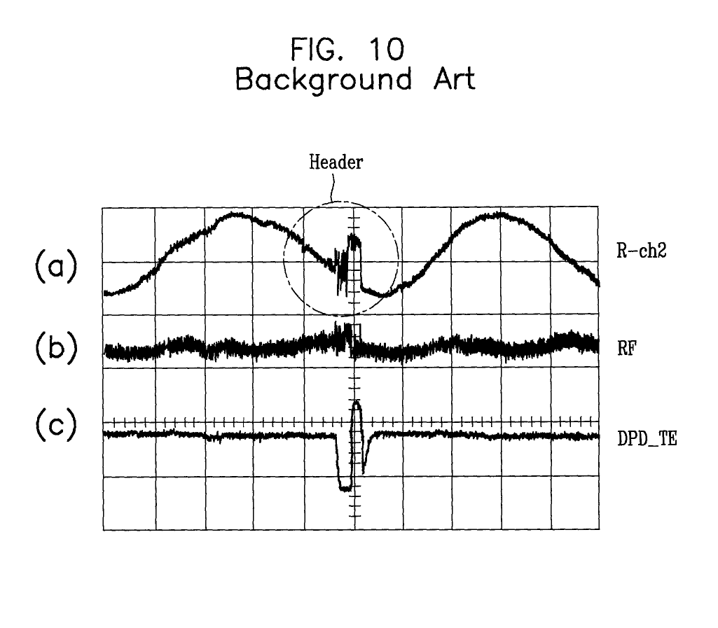

Typically, in case of a DVD-RAM, the tracking error signal is detected by a DPD method in a pre-pit region, and by a PP method in other regions. At this time, since a header region is the pre-pit region, the DPD signal detected therein becomes larger as shown in FIGS. 9C and 10C. This is because the read channel 2 signal and the RF signal detected in the header region are greatly distorted due to detrack and defocus, but the tracking error (TE) signal detected by the DPD method has a phase relationship and thus the degree of distortion becomes smaller.

FIGS. 8A to 8C, 9A to 9C, and 10A to 10C illustrate examples of signals detected by the DPD method during the traverse operation. Specifically, FIGS. 8A, 9A, and 10A show the read channel 2 signal, FIGS. 8B, 9B, and 10B show the RF signal, and FIGS. 8C, 9C, and 10C show the tracking error (TE) signal detected by the DPD method. At this time, FIGS. 8A to 8C show the waveforms detected in the recording region during the traverse operation, and the header region appears well in the header region. However, as the optical disc has a high density and high speed, the detection of the header region from the RF signal becomes difficult. In FIGS. 9A to 9C and 10A to 10C, the header region detected in the non-recording region during the traverse operation is enlarged. Specifically, FIGS. 9A to 9C show the header region in a groove track, and FIGS. 10A to 10C show the header region in a land track. In the non-recording region as shown in FIGS. 9A to 9C and 10A to 10C, the RF signal is almost in a reference level even in the header region, and thus it is difficult to detect the header region using the RF signal. However, it can be recognized that the TE signal detected by the DPD method as shown in FIGS. 8C, 9C, and 10C is largely generated in the header region. That is, the DPD signal is not generated well if the track is in an off or on state or in the data recording region, but is generated well in the header region since the header region is the pre-pit region.

According to the present invention, the header region is detected using the DPD signal, the land/groove is discriminated, and the detected header region is used for the data recording/reproduction.

FIG. 11 is a block diagram illustrating the construction of the optical recording medium recording/reproducing apparatus according to the present invention that performs the data recording/reproduction and track jump by detecting the header region from the DPD signal. In FIG. 11, only the header region detection and control part is illustrated.

Referring to FIG. 11, the apparatus includes a DPD signal generating section 301 for receiving electric signals a, b, c, and d outputted from the optical detector and detecting the tracking error signal DPD_TE, an upper slicing section 302 for slicing the DPD signal DPD_TE with a predetermined upper slice level, a lower slicing section 303 for slicing the DPD signal DPD_TE with a predetermined lower slice level, a land/groove signal generating section 304 for generating a land/groove discrimination signal L/G SW by comparing phases of an output signal DPD_IP1 of the upper slicing section 302 and an output signal DPD_IP2 of the lower slicing section 303, a header mask (HDM) generating section 305 for generating a header mask (HDM) signal from the output signal DPD_IP1 of the upper slicing section 302 and the output signal DPD_TP2 of the lower slicing section 303, a PP signal generating section 306 for receiving the electric signals a, b, c, and d outputted from the optical detector and detecting the TE signal PP_TE by the PP method, a TE sampling and holding section 307 for sampling and holding the push-pull signal PP_TE according to the HDM signal outputted from the HDM generating section 305, a TZC generating section 308 for generating a TZC signal from the TE signal outputted through the TE sampling and holding section 307, a counter 309 for counting the TZC signal generated from the TZC generating section 308, an FE signal generating section 310 for receiving the electric signals a, b, c, and d outputted from the optical detector and detecting an FE signal, an FE sampling and holding section 311 for sampling and holding the FE signal according to the HDM signal, and a control section 312 for receiving the land/groove discrimination signal, HDM signal, TE or sampled and held TE signal, FE or sampled and held FE signal, counted track number, etc., and controlling the recording/reproduction, track jump, etc., of the optical disc.

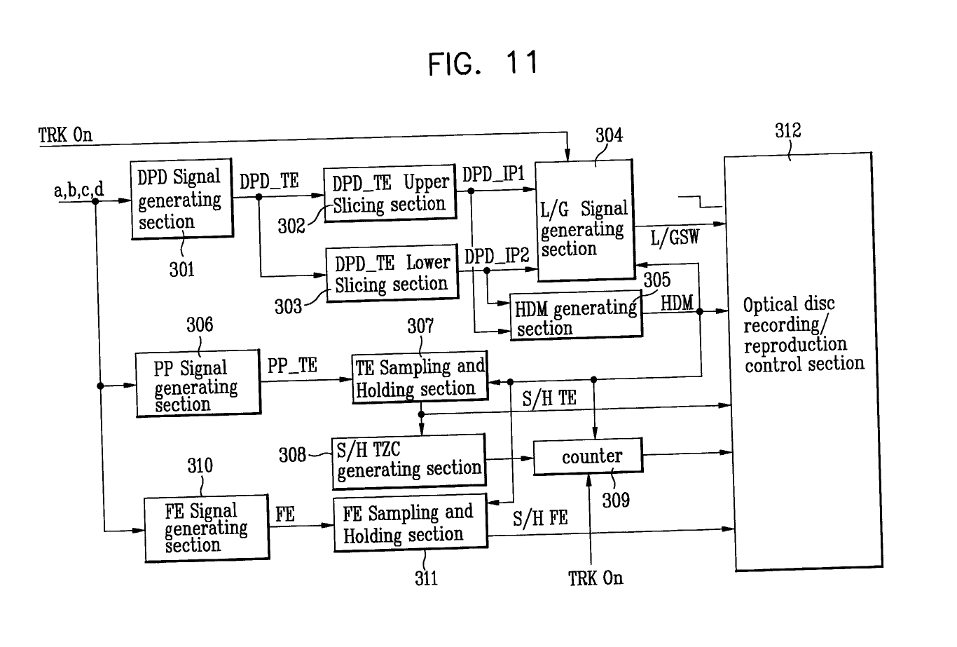

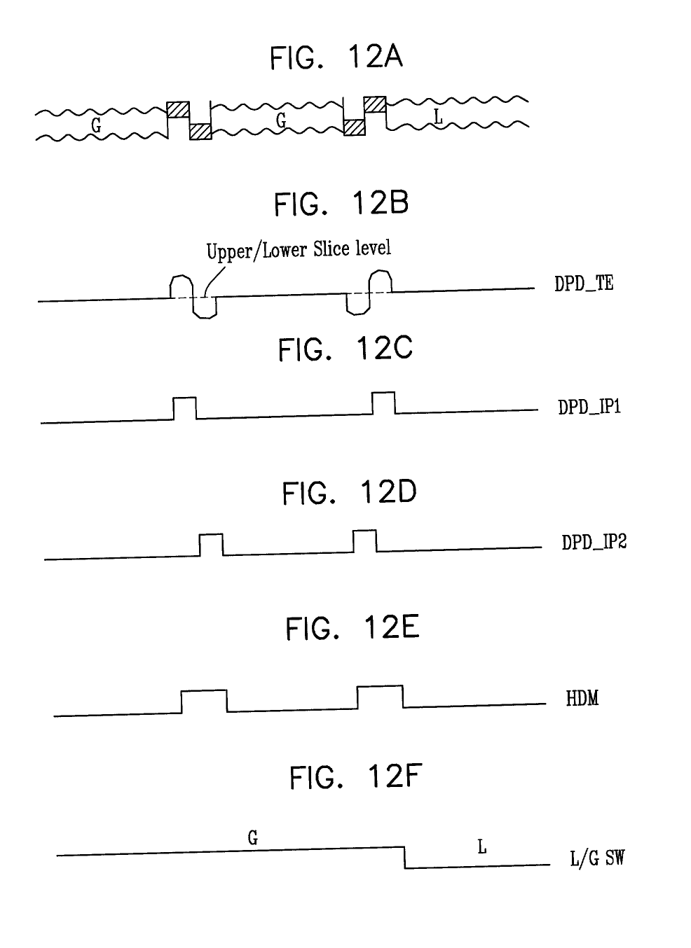

The DPD signal generating section 301 receives the electric signals a, b, c, and d outputted from the optical detector in the optical pickup 102, and detects the TE signal DPD_TE by the DPD method as shown in FIG. 12B to output the detected TE signal to the upper slicing section 302 and the lower slicing section 303. Here, the upper slice level and the lower slice level may be properly determined, and for example, they may be determined as the TZC position.

Also, the PP signal generating section 306 receives the electric signals a, b, c, and d outputted from the optical detector, and detects the TE signal by the PP method to output the detected TE signal to the TE sampling and holding section 307. Here, the TE signals by the DPD method and the PP method can be detected in the same manner as described above.

The FE signal generating section 310 receives the electric signals a, b, c, and d outputted from the optical detector, and generating the FE signal by calculating (a+d)-(b+c) to output the generated FE signal to the FE sampling and holding section 311.

At this time, the upper slicing section 302 slices the DPD signal DPD_TE outputted from the DPD signal generating section 301 with the predetermined upper slice level as shown in FIG. 12C, and outputs a resultant signal DPD_IP1 to the land/groove signal generating section 304 and the HDM generating section 305. The lower slicing section 303 slices the DPD signal DPD_TE outputted from the DPD signal generating section 301 with the predetermined lower slice level as shown in FIG. 12D, and outputs a resultant signal DPD_IP2 to the land/groove signal generating section 304 and the HDM generating section 305. Specifically, if the DPD signal DPD_TE is higher than the predetermined upper slice level, the upper slicing section 302 outputs the DPD_IP1 signal as shown in FIG. 12C, and if the DPD signal DPD_TE signal is lower than the predetermined lower slice level, the lower slicing section 303 outputs the DPD_IP2 signal as shown in FIG. 12D.

The HDM generating section 305 generates the header mask (HDM) signal representing the header region as shown in FIG. 12E by OR-gating the DPD_IP1 signal and the DPD_IP2 signal. The HDM signal is outputted to the land/groove signal generating section 304 for the land/groove discrimination, and also to the TE sampling and holding section 307 and the FE sampling and holding section 311 for sampling and holding of the TE signal and the FE signal. Also, the HDM signal is outputted to the counter 309 for the track jump, and also to the control section 312 for the optical disc recording/reproduction.

At this time, if a signal TRK On representing the track-on and the HDM signal are inputted to the land/groove signal generating section 304, it discriminates whether the signal track following the header region is the land or the groove by comparing the phase difference between the DPD_IP1 signal and the DPD_IP2 signal detected in the header region. Then, the land/groove signal generating section 304 generates the land/groove discrimination signal L/G SW as shown in FIG. 12F according to the result of discrimination. This is because the phases of the DPD_IP1 signal and the DPD_IP2 signal detected in the header region are change each other according to the currently following track, i.e., whether the currently following track is the land or the groove.

Specifically, according to the land/groove track, the DPD_IP1 signal may come early or the DPD_IP2 signal may come early. For example, it is assumed that in the header region where the land track is switched over to the groove track, the DPD_IP1 signal is detected first by the upper slicing section 302, and then the DPD_IP2 signal is detected by the lower slicing section 303. On the contrary, it is assumed that in the header region where the groove track is switched over to the land track, the DPD_IP2 signal is detected first by the lower slicing section 303, and then the DPD_IP1 signal is detected by the upper slicing section 302.

Thus, the land/groove signal generating section 304 discriminates whether the track that follows the header region used for the discrimination is the land track or the groove track using the phase relationship as described above. If the same signal track follows, it maintains the present land/groove discrimination signal as it is, while if the land is switched over to the groove and vice versa, it toggles the land/groove discrimination signal.

If the HDM signal is inputted from the HDM generating section 305, the TE sampling and holding section 307 holds the TE signal detected by the PP method in the header region, and then outputs the TE signal to the TZC generating section 308 and the control section 312. Also, if the HDM signal is inputted, the FE sampling and holding section 311 holds the FE signal in the header region, and then outputs the FE signal to the control section 312. This means that the focus servo and the tracking servo is performed in the header region using the held TE and FE signals instead of the TE and FE signals detected in the header region. At this time, one of methods of holding the FE and TE signals during the header region is the method of sampling and holding the focus and tracking error values just before the start of the header region. The present invention may adopt this method, or may adopt another method.

Meanwhile, the TE signal in the land is in inverse relation with the TE signal in the groove. That is, the TE signal detected in the land has a polarity opposite to the TE signal detected in the groove. In order to follow both the land and the groove tracks normally, the TE signals obtained from the land and the groove have the same phase.

Also, due to the difference in depth between the land and the groove, DC offsets (i.e., signal amount produced due to the difference in depth between the land and the groove) that the land and the groove basically have are different from each other. That is, if the focus and the tracking that meet the land track are applied to the groove track as they are, the defocus and detrack may be produced in the groove. In the same manner, if the focus and the tracking that meet the groove track are applied to the land track, the defocus and detrack may be also produced due to the difference in depth between the land and the groove.

Accordingly, the control section 312 adjusts the focus error offset that matches the land and the groove, respectively, so that a normal focus servo is performed during a normal servo operation for recording/reproducing the data. Also, in addition to the adjustment of the tracking error offset that matches the land and the groove, respectively, for a normal tracking servo operation, the control section 312 inverts the TE signal detected in the land.

Then, according to the land/groove discrimination signal L/G SW outputted from the land/groove signal generating section 304, i.e., if the present signal track is the land, the control section selects the offset-adjusted FE signal and the inverted TE signal to match the land, while if the present signal track is the groove, the control section selects the non-offset-adjusted FE signal and the non-inverted TE signal to match the groove. Then, the control section controls the focus/tracking (F/T) servo driving section to perform the focus servo and the tracking servo using the FE signal and the TE signal that are offset-adjusted to match the land, or to perform the focus servo and the tracking servo using the FE signal and the TE signal that are offset-adjusted to match the groove. Thus, the data recording/reproduction can be performed with a stable servo operation.

Meanwhile, the TZC generating section generates the TZC signal from the TE signal outputted through the TE sampling and holding section 307, and outputs the generated TZC signal to the counter 309. At this time, since the TE signal is a signal from which the effect of the header has already been removed, the TZC signal generated from the TE signal is also a signal from which the effect of the header has been removed. That is, the TZC signal is turned on/off at a time point of track cross, and thus can be obtained by slicing the TE signal sampled and held in the header region with the internal reference level, i.e., at the track zero cross position.

The counter 309 counts the pulse number of the TZCV signal according to the TRK On signal and the HDM signal during the track jump or traverse operation, and output the number of moved tracks to the control section 312.

Accordingly, the control section 312 can control to move the optical pickup to a desired position during the track jump or traverse operation, and to accurately measure the amount of eccentricity of the disc during the free running.

Typically, the DVD recording/reproducing apparatus is provided with not only the PP signal generating section 306 for generating the TE signal by the PP method but also the DPD signal generating section 301. Accordingly, the present invention can accurately and stably perform the header region detection and the land/groove discrimination during the free running or traverse operation without adding separate hardware.

As described above, the header region detecting method and apparatus and recording/reproducing method using thereof according to the present invention accurately and stably detect the header region even during the free running or traverse operation using the TE signal detected by the DPD method, and thus have the following advantages.

First, the error of the track jump count generated due to the excessive generation of the TZC can be removed. For example, since the optical pickup can be moved to a desired position during the seek operation such as the track jump, any slow seek and unstable servo can be prevented.

Second, since the focus is in an on state even in the above-described case, the stability of the focus servo can be secured and the noise can be removed by masking the FE signal in the header region.

Third, the data detection time and the data access time can be reduced by rapidly stabilizing the rotating speed of a target position using the period or counted value of the header signal detected during the free running.

Fourth, the servo is stabilized by accurately and stably holding the servo error signal such as the FE or TE signal in the header region, and thus the deterioration of data quality can be prevented during the recording/reproducing operation.

Fifth, since the header does not affect the measurement of the eccentric amount of the disc, the amount of eccentricity can be accurately measured.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method of detecting a header region including a plurality of header fields having different phases and arranged between rewritable data regions of an optical recording medium for discrimination of shapes of the data regions, the method comprising the steps of:
(a) generating a tracking error signal by detecting an RF signal from an optical reflected signal inputted from the optical recording medium and obtaining a phase difference of optical reflected signals in a radial direction based on the RF signal;
(b) generating first and second header detection signals by slicing the generated tracking error signal with a predetermined slice level; and
(c) generating a signal representing a header region by logically combining the first and second header detection signals.

2. The method as claimed in claim 1, further comprising the step of generating a track zero crossing (TZC) signal from which an effect of the header region is removed if the header region is detected at the step (c).

3. The method as claimed in claim 2, wherein at the step (b), the slice level for slicing the tracking error signal corresponds to a TZC position.

4. The method as claimed in claim 1, wherein at the step (b), if the tracking error signal is higher than the slice level, the first header detection signal is generated, while if the tracking error signal is lower than the slice level, the second header detection signal is generated.

5. The method as claimed in claim 4, wherein the slice level for generating the first header detection signal is equal to or different from the slice level for generating the second header detection signal.

6. The method as claimed in claim 1, further comprising the step of performing a servo control by sampling and holding the servo error signal if the signal representing the header region is inputted at the step (c).

7. The method as claimed in claim 1, further comprising the step of discriminating whether a present track is a land signal track or a groove signal track by comparing phases of the first and second header detection signals generated at the step (b), a nd generating a land/groove discrimination signal according to a result of discrimination.

8. A recording/reproducing method for an optical recording medium in which a header region composed of a plurality of header fields having different phases is arranged between rewritable data regions of the optical recording medium for discrimination of shapes of the data regions, the method comprising the steps of:
(a) generating a tracking error signal by detecting an RF signal from an optical reflected signal inputted from the optical recording medium and obtaining a phase difference of optical reflected signals in a radial direction based on the RF signal;
(b) generating a tracking error signal by receiving two optical reflected signals divided in a track direction from the optical recording medium and obtaining a difference between the two optical reflected signals;
(c) generating first and second header detection signals by slicing the tracking error signal generated at the step (a) with a predetermined slice level, and generating a signal representing a header region by logically combining the first and second header detection signals;
(d) discriminating whether a present track is a land signal track or a groove signal track by comparing phases of the first and second header detection signals, and generating a land/groove discrimination signal according to a result of discrimination; and
(e) recording/reproducing data by performing a tracking control by sampling and holding the tracking error signal generated at the step (b) if the signal representing the header region is inputted at the step (c), and by performing a tracking control by the tracking error signal generated at the step (b) in other cases.

9. The method as claimed in claim 8, wherein at the step (c), if the tracking error signal generated at the step (a) is higher than the slice level, the first header detection signal is generated, while if the tracking error signal is lower than the slice level, the second header detection signal is generated.

10. The method as claimed in claim 9, wherein the slice level for generating the first header detection signal is equal to or different from the slice level for generating the second header detection signal.

11. The method as claimed in claim 10, wherein if the slice level for generating the first header detection signal is equal to the slice level for generating the second header detection signal, the slice level corresponds to a track zero cross (TZC) position of the tracking error signal.

12. The method as claimed in claim 8, wherein at the step (e), if the land/groove discrimination signal represents the groove signal track, a tracking servo is performed by offset-adjusting the tracking error signal to match the groove signal track, while if the land/groove discrimination signal represents the land signal track, a tracking servo is performed by offset-adjusting and inverting the tracking error signal to match the land signal track.

13. An apparatus for detecting a header region including a plurality of header fields having different phases and arranged between rewritable data regions of an optical recording medium for discrimination of shapes of the data regions, the apparatus comprising:
a differential phase detection (DPD) signal generating section for generating a tracking error signal by detecting an RF signal from an optical reflected signal inputted from the optical recording medium and obtaining a phase difference of optical reflected signals in a radial direction based on the RF signal;
a slicing section for generating first and second header detection signals by slicing the tracking error signal generated by the DPD signal generating section with a predetermined slice level; and
a header region discriminating section for generating a signal representing a header region by logically combining the first and second header detection signals.

14. The apparatus as claimed in claim 13, further comprising a servo control section for performing a servo control by sampling and holding the servo error signal if the signal representing the header region is outputted from the header region discriminating section.

15. The apparatus as claimed in claim 14, wherein the servo control section samples and holds the tracking error signal detected by a push-pull method and then performing a tracking servo using the held tracking error signal if the signal representing the header region is outputted from the header region discriminating section.

16. The apparatus as claimed in claim 13, further comprising a land/groove signal generating section for discriminating whether a present track is a land signal track or a groove signal track by comparing phases of the first and second header detection signals generated from the slicing section, and generating a land/groove discrimination signal according to a result of discrimination.

17. The apparatus as claimed in claim 14, wherein the servo control section performs a tracking servo by offset-adjusting the tracking error signal to match the groove signal track if the land/groove discrimination signal represents the groove signal track, while performs a tracking servo by offset-adjusting and inverting the tracking error signal to match the land signal track if the land/groove discrimination signal represents the land signal track.

18. A recording/reproducing apparatus for an optical recording medium in which a header region composed of a plurality of header fields having different phases is arranged between rewritable data regions of the optical recording medium for discrimination of shapes of the data regions, the apparatus comprising:
a differential phase detection (DPD) signal generating section for generating a tracking error signal by detecting an RF signal from an optical reflected signal inputted from the optical recording medium and obtaining a phase difference of optical reflected signals in a radial direction based on the RF signal;
a push-pull signal generating section for generating a tracking error signal by receiving two optical reflected signals divided in a track direction from the optical recording medium and obtaining a difference between the two optical reflected signals;
a header region detecting section for generating first and second header detection signals by slicing the tracking error signal generated from the DPD signal generating section with a predetermined slice level, and generating a signal representing a header region by logically combining the first and second header detection signals;
a land/groove signal generating section for discriminating whether a present track is a land signal track or a groove signal track by comparing phases of the first and second header detection signals from the header region detecting section, and generating a land/groove discrimination signal according to a result of discrimination; and
a servo control section for recording/reproducing data by performing a tracking control by sampling and holding the tracking error signal generated from the push-pull signal generating section if the signal representing the header region is inputted from the header region detecting section, and by performing a tracking control by the tracking error signal that is not sampled and held in other cases.

19. The apparatus as claimed in claim 18, wherein the header region detecting section generates the first header detection signal if the tracking error signal detected by the DPD signal generating section is higher than the slice level, while it generates the second header detection signal if the tracking error signal is lower than the slice level.

20. The apparatus as claimed in claim 18, wherein if the land/groove discrimination signal from the land/groove discriminating section represents the groove signal track, the servo control section performs a tracking servo by offset-adjusting the tracking error signal to match the groove signal track, while if the land/groove discrimination signal represents the land signal track, it performs a tracking servo by offset-adjusting and inverting the tracking error signal to match the land signal track.
